(19) United States
(12) Patent Application Publication
(10) Pub. No.: US 2018/0067935 A1
(43) Pub. Date: Mar. 8, 2018

(54) SYSTEMS AND METHODS FOR DIGITAL MEDIA CONTENT SEARCH AND RECOMMENDATION

(71) Applicants: Prakash Kumar, Bangalore (IN); Agnibesh Dutta, Bangalore (IN); Abhiroop Chatterjee, Bangalore (IN)

(72) Inventors: Prakash Kumar, Bangalore (IN); Agnibesh Dutta, Bangalore (IN); Abhiroop Chatterjee, Bangalore (IN)

(21) Appl. No.: 15/811,152

(22) Filed: Nov. 13, 2017

(30) Foreign Application Priority Data
Aug. 24, 2017 (IN) 201741030023

(51) Int. Cl. G06F 17/30

(52) U.S. Cl. CPC G06F 17/30029; G06F 17/3097; G06F 17/30038

(57) ABSTRACT

Disclosed herein are methods and systems for digital media content search and recommendation. The system analyses large number of reviews and creates a metadata attributes which define particular media content. These attributes are based on experience of a large number of people and therefore are representative of a large audience. The system further uses these attributes to recommend media items based on users view history or based on users search parameters. According to the preferred embodiment, the method to execute the present invention is divided into three phases: training, tagging and search and recommendation phase. The training phase includes processing large number of text reviews of a wide range of movies to determine commonly talked about attributes and creates a global attribute dictionary. In tagging phase, each movie is tagged and classified based on the dictionaries and further movies are recommended depending on users search criterion and view history.

### TECHNICAL FIELD

The embodiments herein generally relate to the field of digital media content and more particularly, to a computer-implemented digital media content search and recommendation.

### BACKGROUND

The volume of digital media content available on internet is growing rapidly and recommendation systems play an important role in determining who will consume which content and how. From Amazon's product recommendation to Netflix's movie recommendation, such systems govern what products people will buy, and what movies they will watch. Given their importance there is an increasing focus on developing intelligent recommendation systems which can guide people in making choices based on their interests.

Content providers deploy recommendation systems to help people discover content of their interest. Media recommendation is a field where the system can recommend media items either based on view history or based on specific query. Most media recommendation systems today employ mainly two techniques. One is like-based and the other is static metadata based.

In like-based system, media items are related to one another based on whether they are liked by the same person. If two movies are liked by same person and this is observed for a large number of people, then it is deduced that those two movies have one or more common attributes and they may be of same taste.

In metadata-based system, items are tagged with metadata (attributes) to enable cataloguing and searching. The metadata is created statically at the time of cataloguing and it does not evolve with time. For example, a movie can be tagged by the content provider as belonging to “action” genre and, by that definition, it can be related to other movies which also belong to “action” genre.

The relevance of recommendations from like-based system generally improves with time as viewing history accumulates. However, relevance may be adversely affected if disparate viewing history of large number of people are combined to generate recommendations. In such cases like-based system may not always capture the attributes of media correctly. For example, a horror movie might get related to a science fiction movie just because they might have same actors. Furthermore, like-based recommendation systems do not provide rich search capabilities.

Static metadata-based systems offer better search capabilities compared to like-based system, however, they have their own drawbacks. First, the metadata is created by few individuals and hence choice of metadata may be subjective and may not represent a larger audience. For example, a critic may classify a movie as belonging to “Action” genre whereas other viewers may classify it as “Comedy” given the combination of Action and Comedy content in the movie. Second, richness of metadata depends on the creativity of the metadata designer. For example, metadata designer may only categorize a movie genre as “Action”. However, it may further be subcategorized as “spy”, “war”, or “comedy” to enable more refined content search. Static metadata based recommendation system does not evolve with time, and most importantly, it does not accommodate views of the end users.

### BRIEF DESCRIPTION OF FIGURES

The embodiments of this invention are illustrated in the accompanying drawings, throughout which like reference letters indicate corresponding parts in the various figures. The embodiments herein will be better understood from the following description with reference to the drawings, in which:

FIG. 1 depicts the present invention at a top level.

FIG. 2 depicts the method for creating global attribute dictionary according to an embodiment of the present invention.

FIG. 3 depicts the method for creating genre attribute dictionary according to an embodiment of the present invention.

FIG. 4 depicts the method for creating a sub-genre attribute dictionary according to an embodiment of the present invention.

FIG. 5 depicts the method for finding movie attribute according to an embodiment of the present invention.

FIG. 6 depicts the method for finding movie genre according to an embodiment of the present invention.

FIG. 7 depicts the method for finding movie sub-genre according to an embodiment of the present invention.

FIG. 8 depicts the method for finding similar movies for recommendation according to an embodiment of the present invention.

FIG. 9 illustrates the environment in which the system is operated, and various components of the system, according to an embodiment of the present invention.

Like reference numerals refer to corresponding parts throughout the several views of the drawings.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments discussed below include systems and methods that provide a review based digital media content search and recommendation system. According to examples of the preferred embodiments, the digital media content implies movies. Another object of the present invention is to enhance the relevance of the recommendation results by dynamically discovering attributes of the digital media content. Yet another object of the present invention is to vastly improve user experience by making it easier for the users to find their desired digital media content.

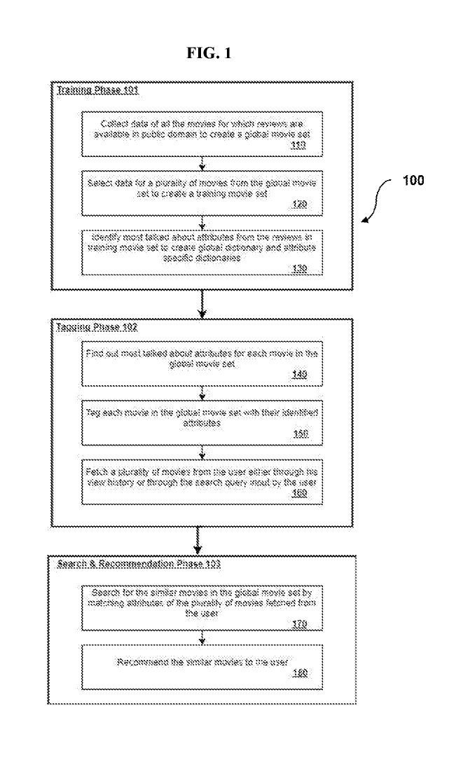

Referring now to the drawings, and more particularly to FIGS. 1 through 9, where similar reference characters denote corresponding features consistently throughout the figures, there are shown embodiments.

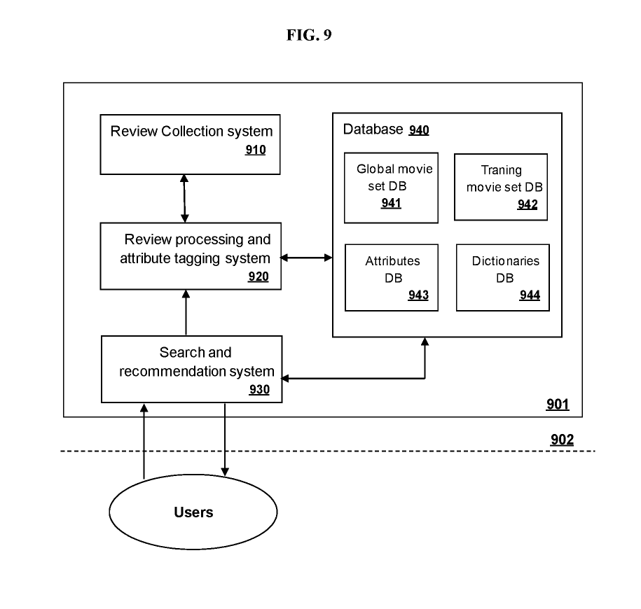

FIG. 9 represents an environment in which the system 901 operates. The system 901 comprises a review collection system 910, a review processing and attribute tagging system 920, and a search and recommendation system 930. The system also includes a system database 940 for storing and recording information, wherein the system database includes at least a global movie set database 941, a training movie set database 942, an attributes database 943, and a dictionaries database 944. In an embodiment, the system 901 communicates with one or more users over one or more networks 902 (ex., over a cellular network).

Referring now to FIG. 1, at top level there are three phases of the method disclosed by the present invention. In an embodiment, the phases comprises of a—training phase 101, a tagging phase 102, and a search and recommendation phase 103, as illustrated by flowchart 100.

In an embodiment, the training phase 101 starts with the review collection system 910 configured to collect review data for all the movies for which reviews are available in public domains (110). The public domains can be at least one of an IMDB, Rotten Tomatoes, and the like. A database comprising the collection of all the movies along with their reviews is thereby created, and is referred to as Global movie set 111 hereinafter. The data for the Global movie set 111 is saved in the global movie set database 941.

From the Global movie set 111, a plurality of movies is selected to create a second database of movies and their reviews (120), this second database is referred to as Training movie set 121 hereinafter and is used to train the system 901. The data for the training movie set 121 is saved in the training movie set database 942. The number of items in the Training movie set 121 can be less than or equal to the number of items in the Global movie set 111. The Global movie set 111 is updated as soon as reviews of a new movie item is added in any of the considered public domains. However, the Training movie set 121 is intermittently updated and the update interval can be configured by the system.

In an embodiment, the review processing and attribute tagging system 920 is configured to process the reviews in the Training movie set 121 to determine most talked-about attributes, and thereafter create a Global dictionary 131 and one or more attribute-specific dictionaries (130).

In the tagging phase 102, the most talked-about attributes for each movie in the Global movie set 111 are identified (140) and then each movie in the Global movie set 111 is tagged by the review processing and attribute tagging system 920 with the corresponding attributes, identified in step 140 (150).

In the search and recommendation phase 103, movies considered relevant for a user, are identified and are recommended to the user by the search and recommendation system 930. In an embodiment, the process begins by fetching a plurality of movie data from the user (160). The movie data from the user is fetched by either accessing the user view history, or by processing the keywords input by the user as a search query. The system then searches for similar or relevant movies within the Global movie set 111 by matching attributes of the movie data fetched from the user in step 160 individually with attributes of each movie in the Global movie set 111 (170). The movies identified to be similar or relevant in step 170 are recommended to the said user on his/her media access device through a web application. The media access device can be one of the devices, but not limited to, such as: a smart phone, a laptop, a smart TV, a desktop etc.

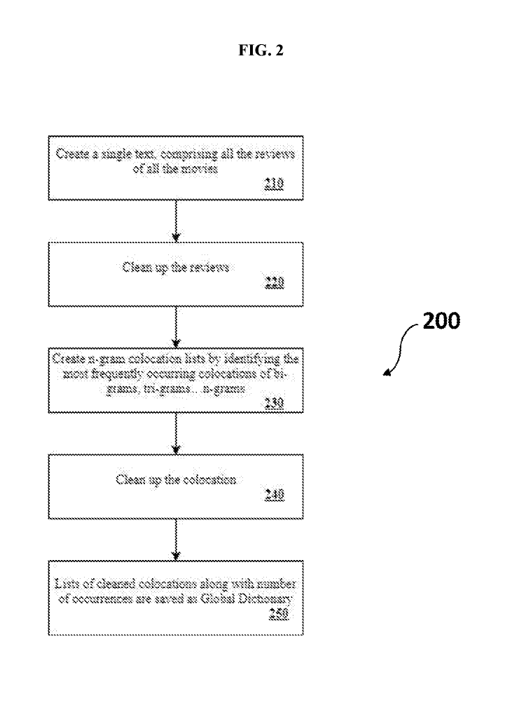

Referring now to FIG. 2, the process for creating Global dictionary 131 is described in detail, as depicted by flowchart 200. First, a single text, or text 211, which is a compilation of all the reviews of all the movies in the Training movie set 111 is created (210). The text 211 is then cleaned up (220); the cleaning process includes cleaning the text of special characters, replacing shortened words with their regular forms (for example “don't” is replaced with ‘do not’), correcting spellings for one-character mistakes, and converting whole text to lowercase.

After cleaning the text 211, n-gram collocation lists are created (230). This is done by using collocation finding algorithms of Natural Language Processing NLTK python library. The collocation algorithm finds each n-grams separately, e.g., bi-grams are collocation of two words based on how often these words occur together. According to an example of the preferred embodiment, the filter was set to six occurrences, which means that collocations are picked up only if they occur more than five times in the text. Each n-gram is saved as a separate list and the list also includes frequency of occurrence of each attribute.

Following lists are created for cleaning up the attributes:
First_word_list: list which contains words that cannot be first word for bi-grams.
Last_word_list: list which contains words that cannot be last word for bi-grams.
Anywhere_word_list: list which contains words that cannot be anywhere in bi-grams.
Adjective_list: list of commonly occurring English adjectives
Special_noun_list: nouns that are specific to movie terminologies like “actor”, “movie”, “production”, “imdb”, “dvd” etc.
Adverb_list: list of commonly occurring English adverbs.
Verb_list: list of commonly occurring English verbs.
Bigram_filter_list: list of bi-grams which are noise and should be removed.
   Trigram_filter_list: list of tri-grams which are noise and should be removedThe n-grams are then cleaned up (240) of unnecessary attributes by applying following rules which use above mentioned lists.
Remove bigrams that contain articles, prepositions, pronouns, conjunctions, interjections and determiners
Remove bigrams which has either of its words in the Anywhere⁺ word_list
Remove bigrams whose first words are in First_word_list
Remove bigrams whose last words are in Last_word_list
Remove bigrams where one word is in Adjective_list and another word in Special_noun_list
Remove bigrams where one word is in Adverb_list and another word in Special_noun_list
Remove bigrams where one word is in Verb_list and another word in Special_noun_list
Remove bigrams where one word is in Adverb_list and another word in Adjective_list
Remove bigrams whose one word is a number in digits
Remove bigrams which are in Bigram_filter_list
Remove trigrams which are in Trigram_filter_list
   Lists of cleaned colocations along with number of occurrences are saved as the Global dictionary 131.

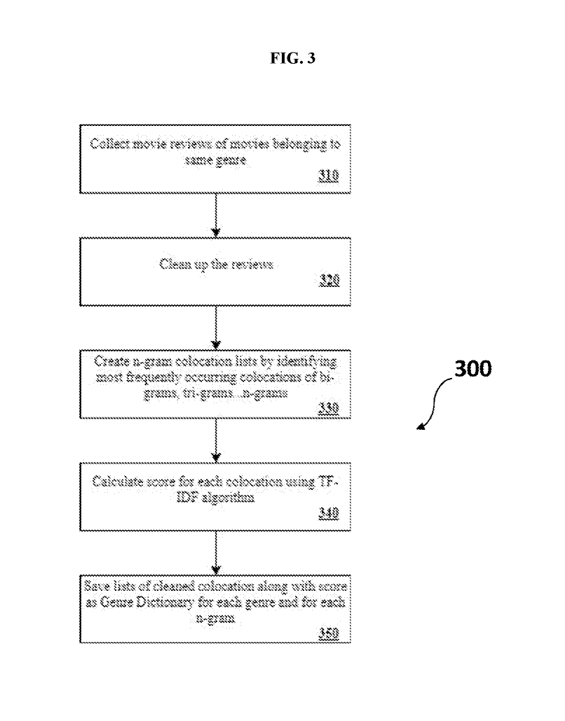

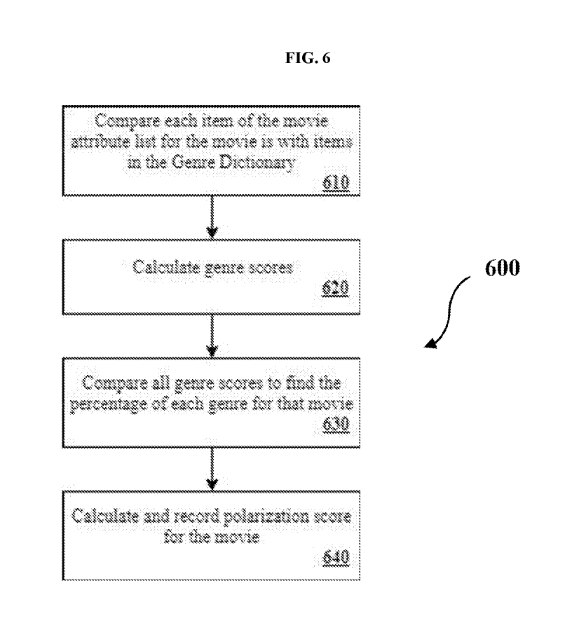

FIG. 3 illustrates a flowchart 300 describing the method to create an attribute dictionary, specifically a Genre dictionary 311. Reviews of the movies belonging to same genre (e.g., Action, Sports, Comedy etc.) are collected (310). The process of identifying the genre of a particular movie is described later with reference to FIG. 6. The reviews are then cleaned up using the cleaning process described at step 220 of flowchart 200.

N-gram collocation lists are then created by identifying most frequently occurring collocations of bi-grams, tri-grams . . . n-grams (330). These attributes are n-grams as already described with reference to FIG. 2.

Further, these genre specific attributes are compared with the Global dictionary 131 to determine the importance of each attribute to each genre through an algorithm called “term frequency-inverse document frequency” (TF-IDF). If the specific attribute is not listed in the Global dictionary 131, then it is discarded. If it exists, then its score is calculated (340) based on the following formula:

Attribute_Score=(No. of occurrence in genre specific list)/(No. of occurrence in Global dictionary)

Lists of cleaned collocation along with scores are saved as Genre dictionary 311 for each genre and for each n-gram.

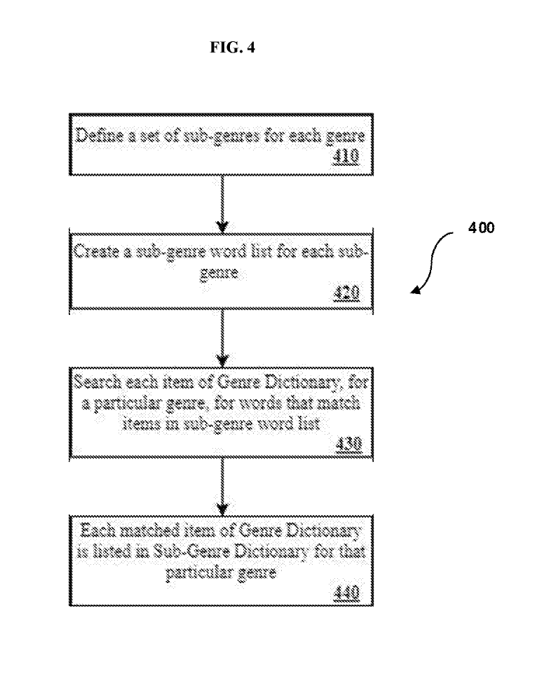

Referring now to FIG. 4, the method of creating a Sub-genre dictionary 411 is described through flowchart 400. First, a set of sub-genres for each genre is defined (410) and a list of words that can define a sub-genre for a particular genre, or a sub-genre word list 421, is made (420). E.g., “tennis” can be a word that can point to a sub-genre “tennis” under genre “sports”.

In an embodiment, each item of Genre dictionary 311 for a particular genre is searched for words that matches items in the sub-genre word list 421 (430). Each matched item of Genre dictionary 311 is listed in the Sub-genre dictionary 411 for that particular sub-genre.

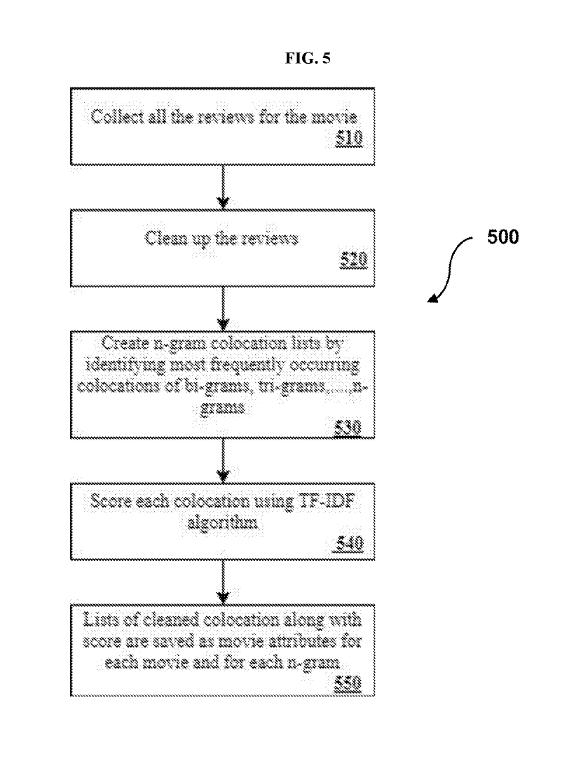

FIG. 5 illustrates a flowchart 500 describing the method of identifying a particular movie's attributes. The reviews of each movie are now processed separately. The first step involves collecting all the reviews for the movie for which the attributes are to be identified (510). The reviews collected are then cleaned up using the cleaning process described at step 220 of flowchart 200 (520).

N-gram collocation lists are created by identifying most frequently occurring collocations of bi-grams, tri-grams . . . n-grams (530). The number of occurrence of each collocation is noted too. The collocations are then compared with the Global dictionary 131 and are then scored according to TF-IDF algorithm (540). The scoring is done with the following formula:

Attribute Score=(Number of occurrence in that movie)/(Number of occurrence in Global dictionary)

The attribute score is again normalized for each movie, the sum of all attribute scores for any movie being ‘1’. For each movie in the Global movie set 111, this procedure is done and the attribute lists are saved along with number of occurrence and the attribute score. This list is saved as Movie attributes list 551(550) and every movie in the Global movie set 111 is tagged with its corresponding Movie attributes list 551.

Referring now to FIG. 6, which depicts a flowchart 600 describing the method to find out the genre of a particular movie. For deducing the genre of a movie, each item of the Movie attributes list 551 for said movie is compared with the items in the Genre dictionary 311(610). If there is a match, genre score for that specific genre for said movie increases by a factor which is multiplication of attribute score of the item being compared and score of said item in the Genre dictionary 311(620). Also, more weightage is given to n-grams with higher “n” value. Genre score is again biased based on the probability of finding number of genre specific attributes. Finally, all genre scores are compared to find the percentage of each genre for that movie (630).

$$( Genre score ) \_ngram = \sum ( matched attribute score in movie ) * ( matched attribute in Genre dictionary )$$

$$Genre score\_prebias = 2 * {( Genre score )}_{2 gram} + 3 * {( Genre score )}_{3 gram} + … + n * {( Genre score )}_{ngram }$$

$$Genre score = Genre {s core}_{prebias} * match\_found \_prob \_in \_movie * match\_found \_prob \_in \_genre \\ Where , \\ match\_found \_prob \_in \_movie = \sqrt{( total genre matches found ) / ( total attribute in that movie )} \\ match\_found \_prob \_in \_genre = \sqrt{( total genre matches found ) / ( total attribute in that genre )}$$

Along with that, a polarization score is also calculated and recorded for each movie (640), the polarization score being a measure of how confident the system is on the score and how polarized the movie is towards a single genre.

$$polarization\_strength = {\sum }_{over all genres} match\_found \_prob \_in \_movie * match\_found \_prob \_total \_occ * \frac{1}{\sqrt{total genre attribute count}} * \sqrt[4]{total movie attributes} * \sqrt[4]{total\_movie \_attrib \_occ \_found}$$

Where total_movie_attrib_occ_found is the summation of occurrences for all the attributes in that movie.

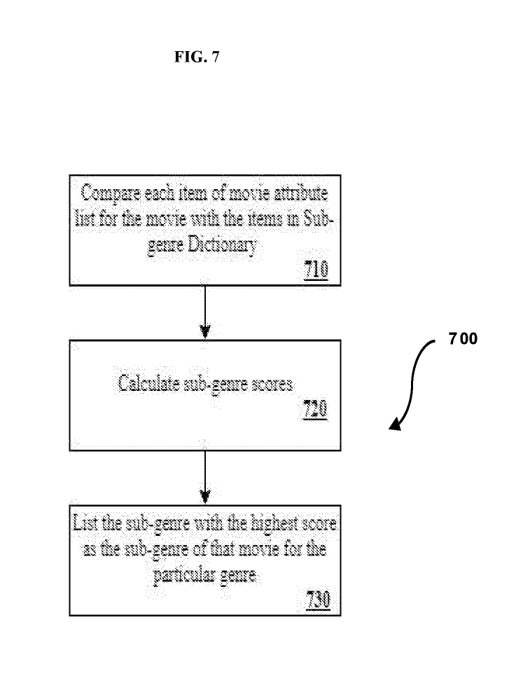

Referring now to FIG. 7, which depicts a flowchart 700 describing the method to find out the sub-genre of a particular movie. For deducing the sub-genre of a movie, each item of the Movie attributes list 551 for said movie is compared with the items in the Sub-genre dictionary 411(710). Sub-genre score for each sub-genre is calculated (720). If there is a match, sub-genre score for that specific subgenre for said movie increases by a factor which is equal to the score of the item in the Movie attributes list 551. The subgenre which has the highest score is listed as the sub-genre of that movie for that particular genre (730).

According to the examples of the preferred embodiment, another attribute for movies is Movie Sentiment. The method for identifying the one or more sentiments associated with a particular movie is described hereafter.

Following lists are made for deducing the sentiments of a movie:
Sentiment_list: list of common English words that can define sentiment.
Movie_synonym_list: list of nouns which can denote “movie” like words or plot of the movie. E.g., “movie”, “film”, “plot”, “story” etc.
Sentiment_synonym_list: sentiment words are grouped as similar sentiments with one top word for each group. E.g., “Delightful”, “Charming”, “Enjoyable”. “Entertaining” are all grouped under the similar sentiment group called “Delightful”.
   Each bi-gram item of the Movie attributes list 551 for said movie is compared for, if the bi-gram is a combination of one word from Sentiment_list and another from Movie_synonym_list. For each bi-gram that matches the criteria, the sentiment words are listed along with the number of occurrence. Once the raw sentiments are derived, similar sentiment words are merged as a single entity based on Sentiment_synonym_list. Then based on occurrences, top sentiments for the movie are noted down as the sentiment for that movie as movie_sentiment for each movie.

Yet another attribute for movies according to the examples of the preferred embodiment is Movie Rating. The method for finding the rating of a particular movie is described hereafter. Following lists are made for finding the rating of the movie:
Positive_word_list: list of adjectives that denote positive sentiments
Negative_word_list: list of adjectives that denote negative sentiments
Movie_specific_word_list: list of words that represents synonyms of movie and also different parameters of a movie. E.g., “film”, “direction”, “plot” etc.

Each bi-gram item of the Movie attributes list 551 for said movie is compared for if the bi-gram is a combination of one word from Positive_Word_List and another from Movie_Specific_Word_List. Same procedure is followed for Negative_Word_List. The movie gets a positive score every time there is a match of attribute with Positive_Word_List and the positive score is increased by a factor is equal to the number of occurrences of that attribute in the Movie_Attribute list. Similar procedure is done with Negative_Word_List to find negative score.

In addition to positive and negative scores, a confidence score is calculated and recorded for each movie. The confidence score indicates a measure of how confident the system is on the score and it is based on number of negative or positive words found and the number of attributes the movie has. The confidence score is calculated using the following code:

Confidence=math.sqrt((pos_score+neg_score)/(total_attribs)*math.sqrt(len(attributes)))

### Wherein:

pos_score is score of the positive keywords;
neg_score is the score of the negative keywords;
total_attribs is the sum of occurrences of all attributes of that movie; and
len(attributes) is the total number of attributes for that movie.

Movie rating is deduced as the percentage of positive score among the sum of positive and negative score. This score is then normalized to 10 and listed as Movie_Score. Also, while displaying actual rating of the movie to the user the system takes confidence score into consideration. As the confidence tends to zero the movie rating tends to 5 which is the average rating.

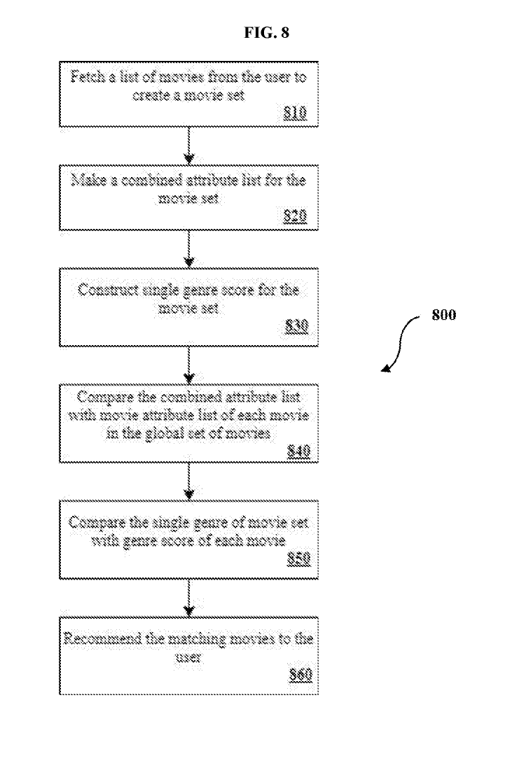

FIG. 8 illustrates a flowchart 800, which describes the process of finding and recommending movies to a user. A list of movies is fetched from the user to create an input movie set 811 comprising one or more movies (810). The list of movies is fetched from the user either by processing user's search query comprising one or more keywords, or by accessing the user's view history. A combined attribute list 821 for all the movies in the input movie set 811 is then created (820). In order to create the combined attribute list 821, the Movie attributes list 551 for each movie in the input movie set 811 is fetched and thereafter all the fetched lists are merged based on their scores. The final score of the combined attribute list 821 is a union of all the attributes of all the movies in the input movie set 811. Whenever an attribute appears multiple times in the merged list their scores are added to merge it into a single entry. Also, a parameter, Tna specific to each n-gram is calculated where Tna is the sum of all n-gram attributes for each Movie attributes list 551 in input movie set 811 and taken average upon total number of movies in the input movie set 811. Similar procedure is done for polarization strength to find a parameter called Tga_pol. One such combined attribute list 821 is made for each n-gram.

$$Tna for each n - gram = \frac{{\sum }_{for each movie} ( \begin{matrix}number of attributes for that n - \\ gram in that movie\end{matrix} )}{total number of input movies}$$

$$Tga\_pol = \frac{{\sum }_{for each movie} ( polarization stength of genre for that movie )}{total number of input movies}$$

Next step is to construct a single genre score for the input movie set 811(830). The genre score of each movie is fetched and a single genre score is constructed. The single genre score is sum of each genre score for each movie and taken average upon total number of input movies.

$$input genre score for each genre = \frac{{\sum }_{for each movie} ( genre score for that movie )}{total number of input movies}$$

Now, another parameter is found for the input movie set 811 and it is called Genre Consistency (GC). This parameter defines how the user's taste is towards choosing the genre of input movies. A higher GC denotes that the user chooses movies aligned towards a particular genre distribution. Lower GC means that the user doesn't care much about genre of the movie and the input movie set is from varied genres. For calculating GC, the standard deviation of each genre (gsd) is calculated for the input movie set. The standard deviation of the polarization strength (psd) is also calculated.

$$gsd = {\sum }_{over all genres} {σ}_{genre} ( \begin{matrix}genre scores in that movie \\ set for that genre\end{matrix} )$$

$$psd = {σ}_{polarization} ( polarization strengths in that movie set )$$

$$sd = gsd * psd … If sd > 0.4 , sd is fixed to 0.4$$

$$G C = 2.5 * ( 0.4 - sd )$$

If number of movies in the input movie set is one, then GC is set to 0.75. The combined attribute list 821 is compared with the Movie attributes list 551 of each movie in global movie set 111 (840) and the single genre score is compared with genre score of each movie in global movie set 111 (850) to find a matching score. The weightage of genre score while finding matching movies is polarized by the Genre Consistency factor.

For each target movie, the Movie attributes list 551 of that movie is compared with the combined attribute list 821 of the input movie set 811. A parameter called TnaTnb is calculated and it is the number of matched attributes. For each n-gram, an attribute match score is calculated which is the sum of all matched attributes and their scores multiplied.

$$attribute\_match \_score \_n = {\sum }_{over all matched attributes} ( score in target movie ) * ( score in combined attribute list of input movies )$$

For each target movie, a parameter called Tnb is found out which is total number of attributes for that movie for a particular n-gram in its Movie attributes list 551. Also, the polarization strength of the target movie is saved as Tgb_pol.

Total attribute list and total matched attribute list for input set and target movies are found out with the following formula.

$$Ta = {\sum }_{over n} Tna$$

$$Tb = {\sum }_{over n} Tnb$$

$$TaTb = {\sum }_{over n} TnaTnb$$

The attribute match score is found out by adding the matched scores of each n-gram with a weightage.

$$attribute\_match \_score \_unbiased = {\sum }_{over n} 10 * ( n - 1 ) * attribute\_match \_score \_n$$

The attribute matched score is biased with the popularity of the target movie and the input movie set 811.

$$popularity\_bias = {log}_{10} \frac{1 + ( Ta + \sqrt{Tb )}}{\sqrt{Tb * TaTb}}$$

$$attribute\_match \_score = \frac{attribute\_match \_score \_unbiased}{popularity\_bias}$$

For each target movie, the genre list of that movie is compared with the combined genre list of the input set. For each genre, a genre match score is found which is the sum of all matched genres and their scores multiplied.

$$genre\_match \_score = {\sum }_{over all genres} ( genre score in target movie ) * ( genre score in combined genre of input movies )$$

The final matched score is found out by adding the attribute_match_score and the genre_match_score with the GC in consideration.

movie_match_score=attribute_match_score+gc*genre_match_score

Based on this movie_match_score movies are recommended (860) for the input movie set 811 in the order of highest matched score.

Further, the user is also enabled to search for particular movies based on certain parameters. The following options are available for the user:
1. Search for movies in particular genre or mix of genre
2. Search movies of a particular sentiment or mix of sentiments
3. Deep search for keywords
4. Mix of any of the top three criteria

The user can either search for sentiments, genres, or keywords separately, or, he can search on a parameter based on a mix of all three. The keywords are nothing but the n-gram attributes from the Global dictionary 111 which is auto-completed as user types. The user search parameter can also include percentage of any particular genre. For example, user can search for movies with 80% action and 20% comedy content.

The embodiments disclosed herein can be implemented through at least one software program running on at least one hardware device and performing network management functions to control the network elements. The network elements shown in FIG. 1 through FIG. 9 include blocks which can be at least one of a hardware device, or a combination of hardware device and software module.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method for searching, and recommending digital media content, the method comprising:
creating a first database comprising a first plurality of digital media content items;
processing users' reviews of the first plurality of digital media content items; and
recommending a second plurality of digital media content items to a user.

2. The method of claim 1, wherein the first plurality of digital media content items are the items for which reviews are available in at least one public domain.

3. The method of claim 1, wherein the digital media content items comprises at least one of, movies, songs, music videos, television shows, and documentaries.

4. The method of claim 1, wherein processing users' reviews further comprises:
creating a second database comprising at least one digital media content item and the corresponding review, of the first database;
implementing collocation on said second database to identify a plurality of most talked about attributes;
creating a global attribute dictionary comprising the plurality of most talked about attributes;
dynamically discovering characteristic attributes of each digital media content item in the first database; and tagging each digital media content item in the first database with said characteristic attributes.

5. The method of claim 4, wherein the characteristic attribute is at least one of genre, sub-genre, sentiment, or rating of the digital media content item.

6. The method of claim 4, wherein the method further comprises creating at least one attribute-specific dictionary.

7. The method of claim 1, wherein recommending the second plurality of digital media content items to the user further comprises:
fetching a third plurality of digital media content items from the user;
creating a combined attribute list, wherein the combined attribute list comprises characteristic attributes of all the items in the third plurality of digital media content items;
comparing the combined attribute list individually with characteristic attributes of each digital media content item in the first database;
calculating an attribute match score for each digital media content item in the first database; and
creating the second plurality of digital media content items, comprising at least one digital media content items from the first database, ranked in the order of highest matched score.

8. The method of claim 7, wherein the third plurality of digital media content items is fetched from the user through a search query provided by the user.

9. The method of claim 8, wherein the search query comprises at least one attribute attributes and/or percentage of at least one attribute, as keywords.

10. The method of claim 7, wherein the third plurality of digital media content items is fetched by electronically accessing the user's view history.

11. A system for searching, and recommending digital media content, the system comprising:
at least one processor; and
memory storing computer-executable instructions that, when executed by the at least one processor, cause the at least one processor to perform method comprising:
creating a first database comprising a first plurality of digital media content items;
processing users' reviews of the first plurality of digital media content items; and
recommending a second plurality of digital media content items to a user.

12. The system of claim 11, wherein processing users' reviews further comprises:
creating a second database comprising at least one digital media content item and the corresponding reviews, of the first database;
implementing collocation on said second database to identify a plurality of most talked about attributes;
creating a global attribute dictionary comprising the plurality of most talked about attributes; dynamically discovering characteristic attributes of each digital media content item in the first database; and tagging each digital media content item in the first database with said characteristic attributes.

13. The system of claim 11, wherein recommending the second plurality of digital media content items to the user further comprises:
fetching a third plurality of digital media content items from the user;
creating a combined attribute list, wherein the combined attribute list comprises-characteristic attributes of all the items in the third plurality of digital media content items;
comparing the combined attribute list individually with characteristic attributes of each digital media content item in the first database;
calculating an attribute match score for each digital media content item in the first database; and
creating the second plurality of digital media content items, comprising at least one digital media content item from the first database, ranked in the order of highest matched score.

14. The system of claim 11, wherein the system enables the user to provide a search query comprising at least one attribute, and percentage of at least one attribute as keywords.

15. The system of claim 11, wherein the system is enabled to electronically access the user's view history.
